(19) United States
(12) Patent Application Publication
(10) Pub. No.: US 2014/0341610 A1
(43) Pub. Date: Nov. 20, 2014

(54) DEVELOPING UNIT AND IMAGE FORMING APPARATUS HAVING THE SAME

(71) Applicant: SAMSUNG ELECTRONICS CO., LTD., Suwon-si (KR)

(72) Inventors: Ho Jin JANG, Suwon-si (KR); Seung Gweon Lee, Suwon-si (KR); Yong Kwan Cho, Incheon (KR)

(73) Assignee: SAMSUNG ELECTRONICS CO., LTD., Suwon-si (KR)

(21) Appl. No.: 14/277,395

(22) Filed: May 14, 2014

(30) Foreign Application Priority Data
May 16, 2013 (KR) 10-2013-0055418

(51) Int. Cl. G03G 15/04

(52) U.S. Cl. CPC G03G 21/1676
USPC 399/119

(57) ABSTRACT

A developing unit mounted on an image forming apparatus is provided. The developing unit includes a housing, a developing agent storage chamber that is provided inside the housing and in which a developing agent is stored, a developing chamber that communicates with the developing agent storage chamber, a path on which the developing agent is moved from the developing agent storage chamber to the developing chamber, and an opening/closing unit that is provided on the path and is open/closed while interlocking with an operation of mounting the housing on the image forming apparatus. Thus, a leakage of the developing agent can be prevented, and detachment of the developing unit can be easily performed.

### CROSS-REFERENCE TO RELATED APPLICATIONS

This application is related to, and claims priority benefit of, Korean Patent Application No. 10-2013-0055418, filed on May 16, 2013 in the Korean Intellectual Property Office, the disclosure of which is incorporated herein by reference.

### BACKGROUND

1. Field

Embodiments relate to a developing unit and an image forming apparatus having the same, and more particularly, to a developing unit having a structure in which a leakage of a developing agent can be prevented, and an image forming apparatus having the developing unit.

2. Description of the Related Art

Image forming apparatuses are apparatuses for forming an image on a printing medium according to an input signal, such as printers, copying machines, fax machines, and multi-function devices for implementing integrated functions thereof.

In electrophotographic image forming apparatuses, as a type of image forming apparatuses, an electrostatic latent image may be formed on a surface of a photosensitive body by scanning light onto the photosensitive body charged to a predetermined electric potential, and a developing agent may be supplied to the electrostatic latent image, thereby forming a visible developing agent image. The developing agent image formed on the photosensitive body may be transferred directly onto the printing medium or transferred onto the printing medium via an intermediate transfer body, and an image transferred onto the printing medium may be fixed onto the printing medium through a fusing operation.

An image forming apparatus includes a developing unit that stores a developing agent and supplies the developing agent. However, a problem of a leakage of the developing agent occurs when the developing unit is mounted on the image forming apparatus or when the developing unit is separately kept.

### SUMMARY

An aspect of an exemplary embodiment provides an image forming apparatus, which is capable of preventing a leakage of a developing agent and in which a developing unit can be easily mounted on the image forming apparatus.

Additional aspects are be set forth in part in the description which follows and, in part, will be obvious from the description, or may be learned by practice of the invention.

In accordance with an exemplary embodiment, a developing unit mounted on an image forming apparatus, includes a housing, a developing agent storage chamber which is provided inside the housing and in which a developing agent is stored, a developing chamber that communicates with the developing agent storage chamber, a path on which the developing agent is moved from the developing agent storage chamber to the developing chamber, and an opening/closing unit which is provided on the path and is open/closed when the housing is mounted on/detached from the image forming apparatus, wherein the opening/closing unit may include a guide shutter having at least one developing agent supply hole; and a slide shutter that opens/closes the at least one developing agent supply hole of the guide shutter.

The developing unit may include a cap shutter that opens/closes the opening/closing unit when the housing is mounted on/detached from the image forming apparatus.

The cap shutter may include a cap portion that protrudes toward an outside of the housing and moves due to an external force, and a pushing protrusion that extends from the cap portion and causes the slide shutter to slide.

The slide shutter may include at least one developing agent injection hole corresponding to the at least one developing agent supply hole according to sliding movement.

A plurality of developing agent supply holes and a plurality of developing agent injection holes may be provided at the same intervals.

The slide shutter may include a shutter pressurization portion that is provided at one end of the slide shutter so that the slide shutter is capable of sliding in one direction due to an external force applied to the cap shutter, and a shutter elastic member that is provided at the other end of the slide shutter so that the slide shutter is capable of sliding in the other direction due to an elastic force.

The opening/closing unit may slide in one direction due to an external force applied to the shutter pressurization portion and may be open and may slide in the other direction due to an elastic force of the shutter elastic member and may be closed.

The guide shutter may include a guide shutter body that blocks the path on which the developing agent is capable of moving only through the at least one developing agent supply hole.

The guide shutter may include guide rails so that the slide shutter is capable of closely contacting the guide shutter and sliding along the guide rails.

The cap portion may be inserted into the housing when the housing is mounted on the image forming apparatus.

An end of the cap portion may be formed in a hemispherical shape.

The cap shutter may be elastically supported to an outside of the housing.

The cap shutter may include at least one flange guide that extends in a flange shape from the cap portion, and an elastic member provided so that the at least one flange guide is elastically supported on the housing.

The housing may include a guide hole through which movement of the cap shutter is guided.

The developing unit may include a cover plate provided at the outside of the housing so as to prevent detachment of the cap shutter.

The opening/closing unit may include a sealing film that causes the guide shutter and the slide shutter to closely contact each other and that is provided between the guide shutter and the slide shutter so as to prevent a leakage of the developing agent.

In accordance with another aspect of the present invention, an image forming apparatus includes: a body, a developing unit housing including a developing agent storage chamber in which a developing agent is stored and a developing chamber that communicates with the developing agent storage chamber and that has a developing member for transporting the developing agent to a photosensitive body on which an electrostatic latent image is formed, the developing unit housing being mounted on a support unit provided inside the body, a path on which the developing agent is moved from the developing agent storage chamber to the developing chamber, an opening/closing unit including a guide shutter having at least one developing agent supply hole and a slide shutter having developing agent injection holes that selectively correspond to the at least one developing agent supply hole according to sliding movement, the opening/closing unit opening/closing the path, and a cap shutter provided at an end of the slide shutter so as to move the slide shutter.

The support unit may include support rails on which mounting of the developing unit housing is guided, and a chamfer portion that is provided at an end of the support rails and that pressurizes the cap shutter so that the cap shutter is capable of moving to an inside of the developing unit housing.

### BRIEF DESCRIPTION OF THE DRAWINGS

These and/or other aspects of the invention will become apparent and more readily appreciated from the following description of the embodiments, taken in conjunction with the accompanying drawings of which:

FIGS. 1A and 1B illustrate an image forming apparatus in accordance with an embodiment;

FIG. 2A illustrates a developing unit mounted on an image forming apparatus in accordance with an embodiment;

FIG. 2B is a perspective view of a support unit in accordance with an embodiment;

FIG. 3 is an exploded perspective view of a developing unit in accordance with an embodiment;

FIG. 4 is an exploded perspective view of an opening/closing unit and a cap shutter in accordance with an embodiment;

FIG. 5 is a cross-sectional view of an exemplary opening/closing unit;

FIGS. 6A, 6B, 6C, 6D, and 6E illustrate exemplary shapes of the cap shutter;

FIG. 7 illustrates an exemplary development unit housing;

FIG. 8 illustrates an exemplary cover plate and slide shutter;

FIG. 9 is a perspective view of a cap shutter and a storage bracket in accordance with an embodiment; and

FIGS. 10A and 10B illustrate a developing unit mounted on an image forming apparatus in accordance with an embodiment.

### DETAILED DESCRIPTION

Reference will now be made in detail to the embodiments, examples of which are illustrated in the accompanying drawings, wherein like reference numerals refer to like elements throughout.

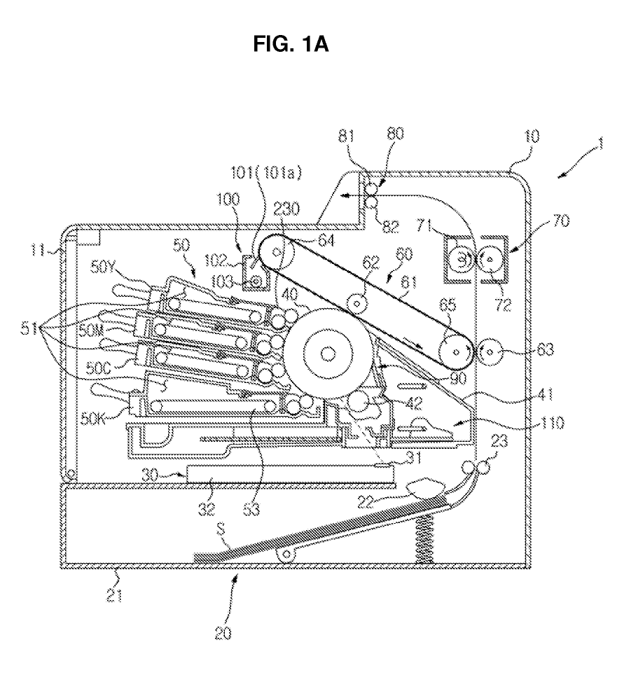

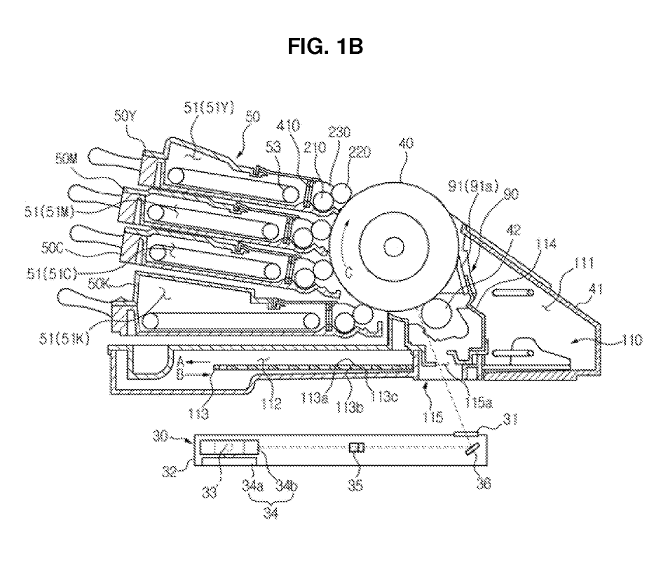

FIGS. 1A and 1B illustrate a configuration of an image forming apparatus in accordance with an embodiment.

As illustrated in FIGS. 1A and 1B, an image forming apparatus 1 includes a main body 10, a printing medium supply unit 20, a light scanning unit 30, a photosensitive body 40, a developing unit 50, a transfer unit 60, a fusing unit 70, and a printing medium discharge unit 80.

The main body 10 forms an exterior of the image forming apparatus 1 and supports various components installed inside the image forming apparatus 1. A main body cover 11 may be rotatably installed at one side of the main body 10. The main body cover 11 opens/closes a portion of the main body 10. A user may access an inside of the main body 10 via the main body cover 11 and may mount/detach various parts including the developing unit 50.

The printing medium supply unit 20 includes a cassette 21 in which a printing medium S is kept, a pickup roller 22 that picks up one printing medium S kept in the cassette 21, and a transfer roller 23 that transfers the picked-up printing medium S to the transfer unit 60.

The light scanning unit 30 scans light onto the photosensitive body 40 so as to form an electrostatic latent image. The light scanning unit 30 scans light corresponding to image information onto the photosensitive body 40 when the image forming apparatus 1 performs a printing operation.

The light scanning unit 30 includes a case 32 having a light-transmitting member 31 so that light can be emitted to the outside, and a scanning optical system mounted inside the case 32.

The scanning optical system includes a light source 33 that emits light, a light deflector 34 that deflects light emitted from the light source 33, an f-θlens 35 that corrects aberration included in light deflected by the light deflector 34, and a reflection mirror 36 that reflects light passing through the f-θlens 35 toward the photosensitive body 40.

The light deflector 34 includes a driving motor 34a and a polygon mirror 34b rotated by the driving motor 34a. The polygon mirror 34b includes a plurality of reflective surfaces formed at sides of the polygon mirror 34b and deflects and scans light incident from the light source 33.

Light emitted from the light source 33 may be deflected by the polygon mirror 34b and reflected by the reflection mirror 36 toward the light-transmitting member 31 via the f-θlens 35.

Light reflected by the reflection mirror 36 passes through the light-transmitting member 31, is emitted to an outside of the case 32 and is radiated onto the photosensitive body 40, and an electrostatic latent image is formed on the surface of the photosensitive body 40. The light-transmitting member 31 may be formed of transparent glass or plastic, and a slit-shaped space in which light transmits without the light-transmitting member 31, may be formed.

The photosensitive body 40 is an image carrier that carries the electrostatic latent image formed by the light scanning unit 30 and a developing agent image formed by the developing unit 50. According to an exemplary embodiment, the photosensitive body 40 is a cylindrical drum type, but may also be a belt type that rotates in a caterpillar track.

The photosensitive body 40 may be rotatably installed at a photosensitive body housing 41 that is attachably/detachably mounted on the main body 10. However, the photosensitive body 40 may be fixed to the main body 10 and may not be detached from the main body 10. A charging member 42 is installed inside the photosensitive body housing 41. The charging member 42 charges the photosensitive body 40 to a predetermined electric potential before light is scanned from the light scanning unit 30. The charging member 42 may be a cylindrical roller type charging member, a corona type charging member linearly formed of a conductive material, or a plate type charging member formed as a plate formed of a conductive material according to implementation methods.

The developing unit 50 supplies a developing agent to the photosensitive body 40 on which the electrostatic latent image is formed, thereby forming a visible developing agent image. The developing unit 50 may include four developing units 50K, 50C, 50M, and 50Y in which developing agents having different colors, for example, black, cyan, magenta, and yellow, are accommodated. The four developing units 50K, 50C, 50M, and 50Y may be referred to as a black developing unit 50K, a cyan developing unit 50C, a magenta developing unit 50M, and a yellow developing unit 50Y.

The developing units 50K, 50C, 50M, and 50Y may be arranged adjacent to each other and parallel to each other along a rotation direction (C-direction) of the photosensitive body 40. The black developing unit 50K, the cyan developing unit 50C, the magenta developing unit 50M, and the yellow developing unit 50Y may be arranged along a rotation direction of the photosensitive body 40. However, embodiments are not limited thereto, and an arrangement order of the developing units 50K, 50C, 50M, and 50Y may vary.

Each of the developing units 50K, 50C, 50M, and 50Y may include respective developing agent storage chambers 51K, 51C, 51M, and 51Y, a supply roller 210, and a developing member 220. In FIG. 1B, a supply roller and a developing member that are installed at the developing unit 50Y are indicated by reference characters “210” and “220”.

A developing agent to be supplied to the photosensitive body 40 is stored in the developing agent storage chambers 51K, 51C, 51M, and 51Y, and the supply roller 210 supplies the developing agent stored in the developing agent storage chambers 51K, 51C, 51M, and 51Y to the developing member 220. The supply roller 210 may be a roller type supply roller or a plate type supply roller according to the configuration of the developing units 50K, 50C, 50M, and 50Y, and the supply roller 210 may be omitted. The developing member 220 adheres the developing agent to the surface of the photosensitive body 40 on which the electrostatic latent image is formed, thereby forming a visible image. The developing member 220 according to an embodiment may be formed of a cylinder-shaped rubber or metal material ort may have a belt or tube shape.

The transfer unit 60 may include an intermediate transfer belt 61, a first transfer roller 62, and a second transfer roller 63.

The intermediate transfer belt 61 may be supported by support rollers 64 and 65 and travels at the same velocity as a linear velocity of the photosensitive body 40. The first transfer roller 62 may face the photosensitive body 40 in a state in which the intermediate transfer belt 61 is placed between the first transfer roller 62 and the photosensitive body 40, and causes the developing agent image formed on the photosensitive body 40 to be transferred onto the intermediate transfer belt 61.

The second transfer roller 63 may face the support roller 65 in a state in which the intermediate transfer belt 61 is placed between the second transfer roller 63 and the support roller 65. The second transfer roller 63 may be spaced apart from the intermediate transfer belt 61 while an image is transferred onto the intermediate transfer belt 61 from the photosensitive body 40, and if the image of the photosensitive body 40 is fully transferred onto the intermediate transfer belt 61, the second transfer roller 63 contacts the intermediate transfer belt 61 with a predetermined pressure. If the second transfer roller 63 contacts the intermediate transfer belt 61, the image of the intermediate transfer belt 61 may be transferred onto the printing medium S.

As illustrated in FIGS. 1A and 1B, the image forming apparatus 1 may include a first cleaning unit 90 that cleans the developing agent that remains on the photosensitive body 40, a second cleaning unit 100 that cleans the developing agent that remains on the intermediate transfer belt 61, and a waste developing agent storage unit 110 that stores a waste developing agent recovered from the photosensitive body 40.

The first cleaning unit 90 includes a cleaning unit 91 disposed to contact the photosensitive body 40. The cleaning unit 91 may contact the photosensitive body 40 and scrape the developing agent that remains on the surface of the photosensitive body 40. The cleaning unit 91 may be configured as a cleaning blade 91a that is installed inside the photosensitive body housing 41 and has, for example, one end contacting the photosensitive body 40.

The second cleaning unit 100 includes a cleaning unit 101 disposed to contact the intermediate transfer belt 61, a waste developing agent collecting box 102 in which the waste developing agent recovered by the cleaning unit 101 from the intermediate transfer belt 61 may be temporarily stored, and a transporting unit 103 that transports the waste developing agent collected in the waste developing agent collecting box 102.

The cleaning unit 101 may be configured as a cleaning blade 101a that has one end being in friction with the intermediate transfer belt 61 and scrapes the developing agent that remains on the surface of the intermediate transfer belt 61. The transporting unit 103 may be configured as an auger that includes a spiral wing, rotates and transports the waste developing agent.

In FIGS. 1A and 1B, the cleaning blades 91a and 101a may be used as the cleaning units 91 and 101. However, a brush type or roller type cleaning unit may also be used.

The waste developing agent storage unit 110 may include a first waste developing agent storage chamber 111, a second waste developing agent storage chamber 112, and a waste developing member 113.

The first waste developing agent storage chamber 111 and the second waste developing agent storage chamber 112 may be disposed inside the photosensitive body housing 41. A support member 114 may be installed at one side of the first waste developing agent storage chamber 111, and the cleaning blade 91a may be fixed to an end of the support member 114. The waste developing agent removed by the cleaning blade 91a from the photosensitive body 40 may be stored in the first waste developing agent storage chamber 111 and is transported by the waste developing member 113 to the second waste developing agent storage chamber 112.

A light window portion 115 may be disposed between the first waste developing agent storage chamber 111 and the second waste developing agent storage chamber 112. The light window portion 115 includes a light transmitting hole 115a that passes through the photosensitive body housing 41 and causes light scanned by the light scanning unit 30 to pass through the photosensitive body housing 41 and to reach the photosensitive body 40.

A developing agent movement path (not shown) may be disposed between the first waste developing agent storage chamber 111 and the second waste developing agent storage chamber 112. The developing agent movement path (not shown) causes the waste developing agent stored in the first waste developing agent storage chamber 111 to make a detour to both sides of the light window portion 115 and to be moved to the second waste developing agent storage chamber 112.

The waste developing member 113 may be installed inside the photosensitive body housing 41 so as to make a rectilinear motion. The waste developing member 113 makes a reciprocating motion in directions A and B, as indicated by arrows in FIG. 1B, and the waste developing agent stored in the first waste developing agent storage chamber 111 and the second waste developing agent storage chamber 112 is transported in the direction A.

The waste developing member 113 includes transporting ribs 113a that are disposed to be spaced apart from each other. One side surface 113b of each of the transporting ribs 113a in a direction in which the waste developing agent is transported, i.e., in the direction A is formed as a vertical surface on which the waste developing agent can be effectively transported. The other side surface 113c of the transporting rib 113a placed at an opposite side to the one side surface 113b may be formed as an inclined surface so that retrogression of the waste developing agent can be minimized when the transporting rib 113a is moved in an opposite direction to the waste developing agent transportation direction.

As illustrated in FIGS. 1A and 1B, the fusing unit 70 may include a heating roller 71 having a heat source and a pressurization roller 72 that is installed to face the heating roller 71. When the printing medium S passes through a space between the heating roller 71 and the pressurization roller 72, an image is fixed onto the printing medium S due to heat transferred from the heating roller 71 and pressure applied between the heating roller 71 and the pressurization roller 72.

The printing medium discharge unit 80 includes a paper discharging roller 81 and a paper discharging backup roller 82 and discharges the printing medium S that passes through the fusing unit 70 to an outside of the main body 10.

An exemplary operation of the image forming apparatus having is described with reference to FIGS. 1A and 1B.

If a printing operation starts, the surface of the photosensitive body 40 may be uniformly charged by the charging member 42. Light corresponding to image information having one color, for example, a yellow color, is radiated by the light scanning unit 30 onto the surface of the photosensitive body 40 that is uniformly charged, and an electrostatic latent image corresponding to an image having the yellow color is formed on the photosensitive body 40.

A developing bias voltage may be applied to the developing member 220 of the yellow developing unit 50Y. Thus, a developing agent having the yellow color is adhered to the electrostatic latent image, and a developing agent image having the yellow color is formed on the photosensitive body 40. The developing agent image may be transferred by the first transfer roller 62 onto the intermediate transfer belt 61.

If transfer of one page having the yellow color is completed, the light scanning unit 30 scans light corresponding to image information having another color, for example, a magenta color, onto the photosensitive body 40, thereby forming an electrostatic latent image corresponding to an image having the magenta color. The magenta developing unit 50M supplies a developing agent having the magenta color to the electrostatic latent image, thereby forming a developing agent image. The developing agent image having the magenta color formed on the photosensitive body 40 is transferred by the first transfer roller 62 onto the intermediate transfer belt 61. The developing agent image having the magenta color overlaps the developing agent image having the yellow color that has been previously transferred.

If the above-described procedure is performed on cyan and black colors, a color image in which yellow, magenta, cyan, and black images overlap each other, may be completed on the intermediate transfer belt 61. The color image completed in this way may be transferred onto the printing medium S that passes through a space between the intermediate transfer belt 61 and the second transfer roller 63, and the printing medium S may be discharged to an outside of the main body 10 via the fusing unit 70 and the printing medium discharge unit 80.

When the developing agent image is transferred onto the intermediate transfer belt 61 or the printing medium S in the printing operation, a partial developing agent may remain on the photosensitive body 40 or the intermediate transfer belt 61 and becomes a waste developing agent. The waste developing agent may be removed by the cleaning blades 91a and 101a that contacts in friction the photosensitive body 40 and the intermediate transfer belt 61.

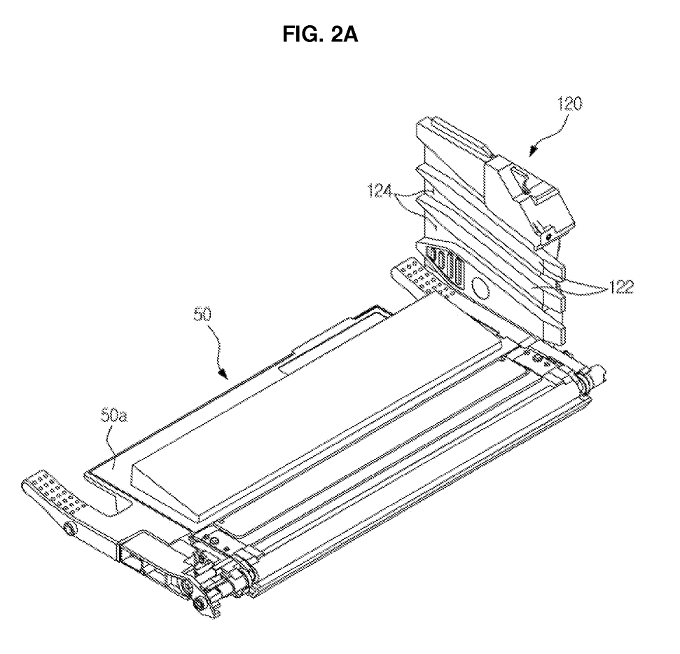

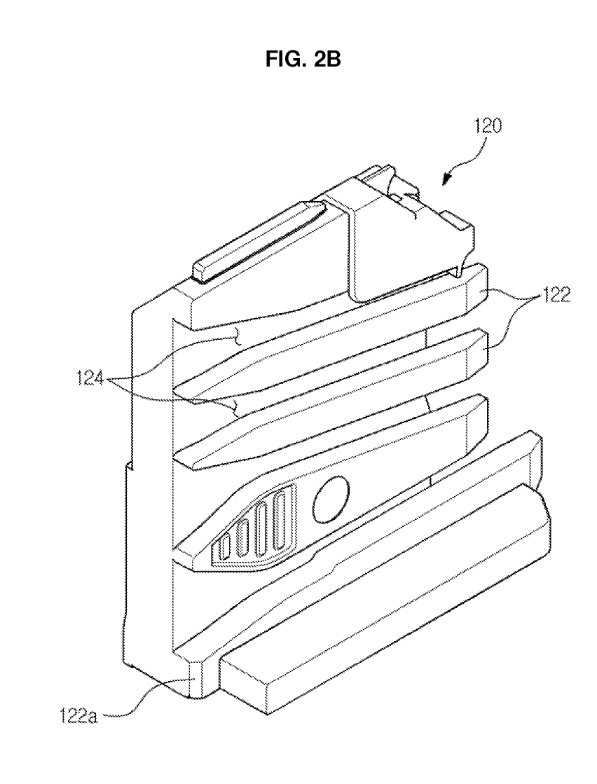

FIG. 2A illustrates a developing unit mounted on an image forming apparatus in accordance with an embodiment, and FIG. 2B is a perspective view of a support unit in accordance with an embodiment.

As illustrated in FIGS. 2A and 2B, a support unit 120 may be disposed inside the image forming apparatus 1 so that the developing units 50 can be coupled to, and mounted on, the support unit 120.

The support unit 120 may include a plurality of developing unit mounting portions 124 into which the developing units 50 can be inserted. The support unit 120 may include a plurality of support rails 122 on which the developing units 50 can be mounted on the plurality of developing unit mounting portions 124.

The developing units 50 may be guided through the plurality of support rails 122 and may be mounted on the developing unit mounting portions 124. A chamfer portion 122a, having a chamfer shape, may be disposed on an end of each of the support rails 122 so that, when the developing units 50 are inserted into, and coupled to, the developing unit mounting portions 124, a cap shutter 450 can be inserted into an inside of each of the developing units 50.

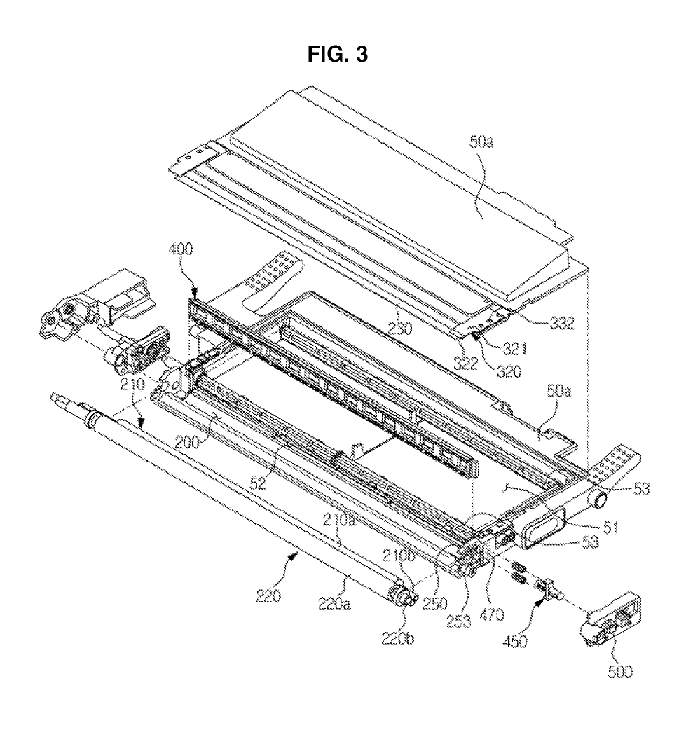

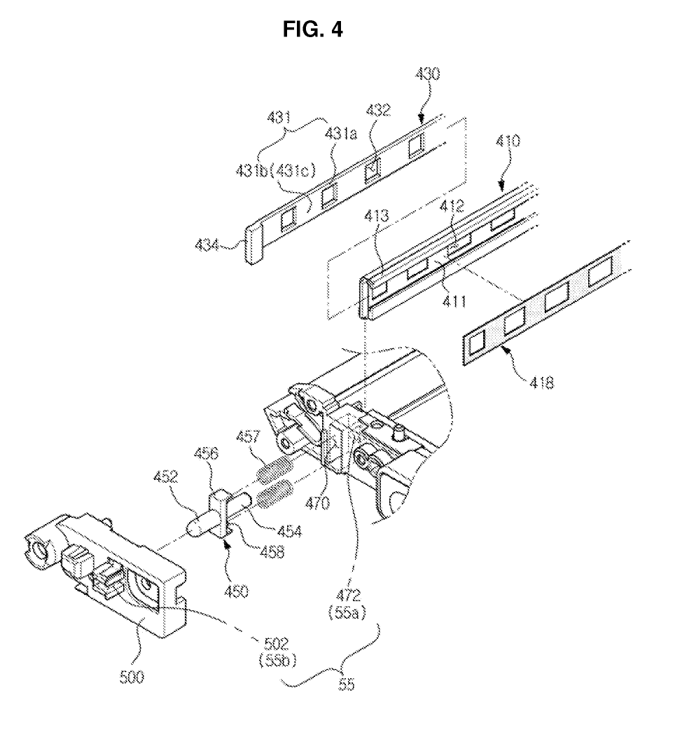

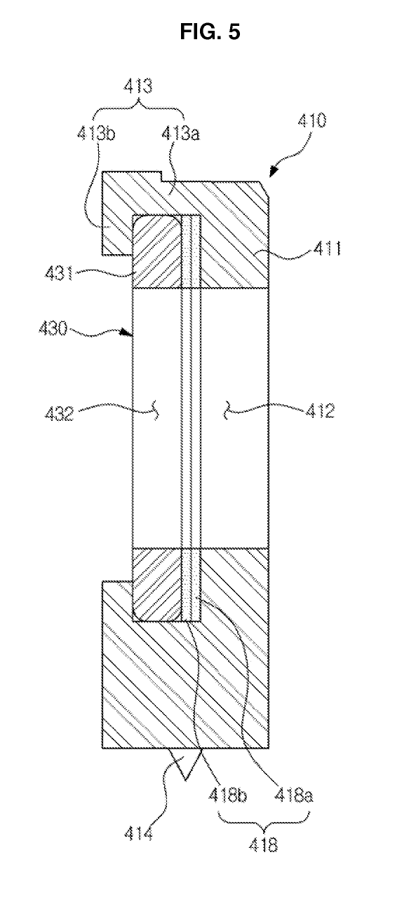

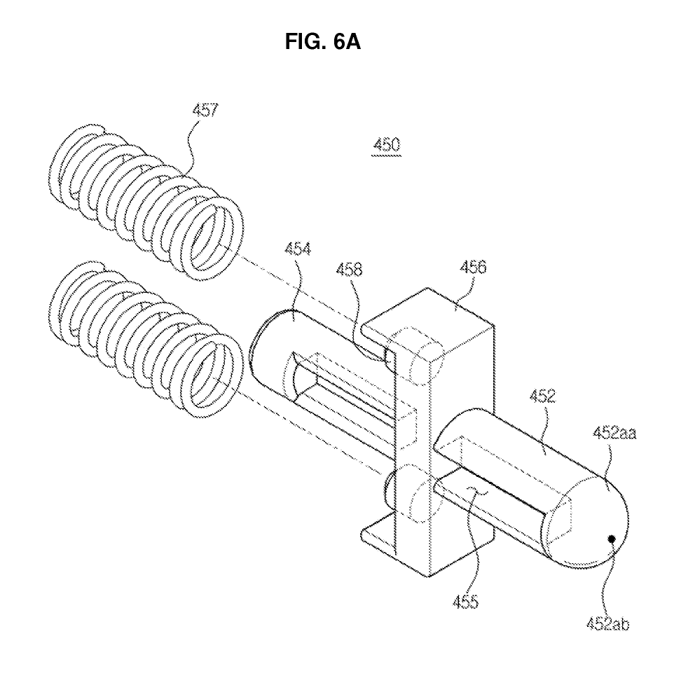

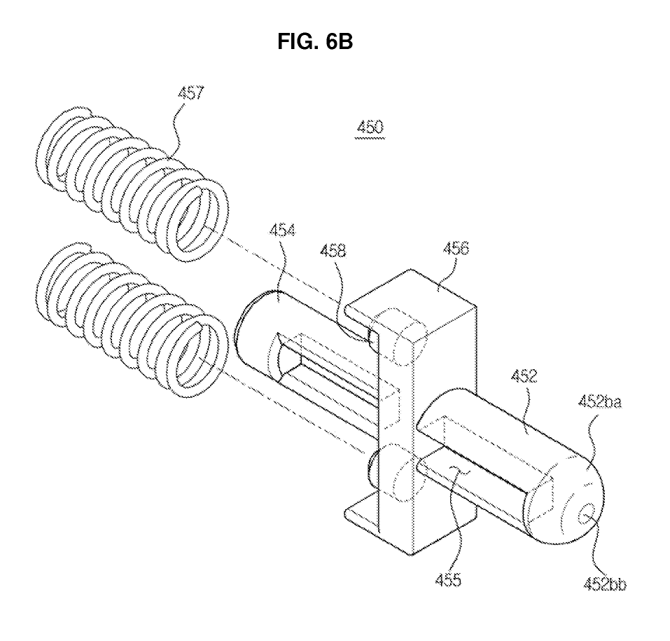

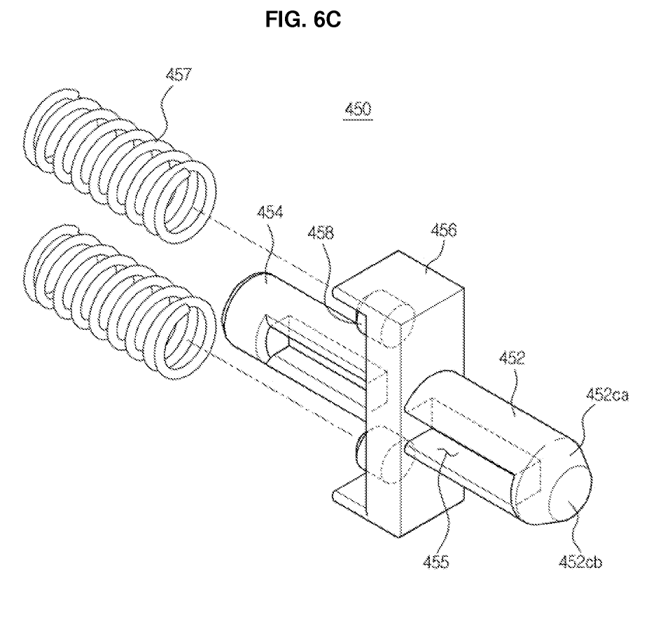

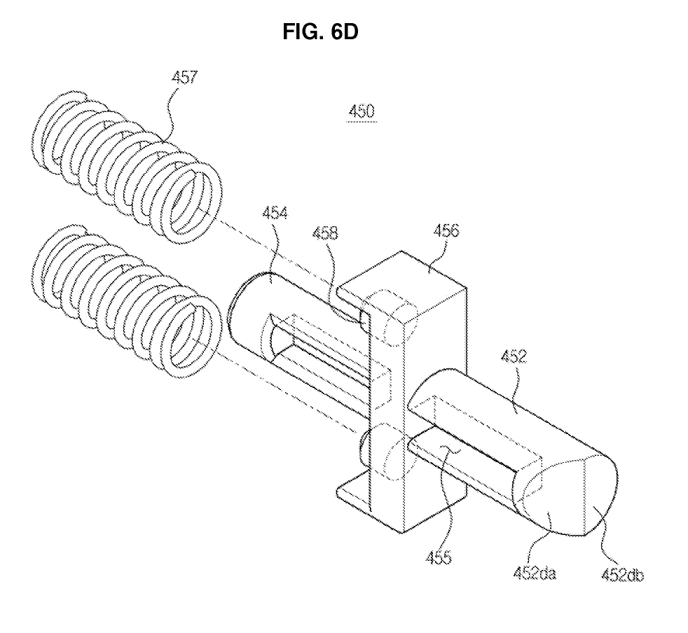

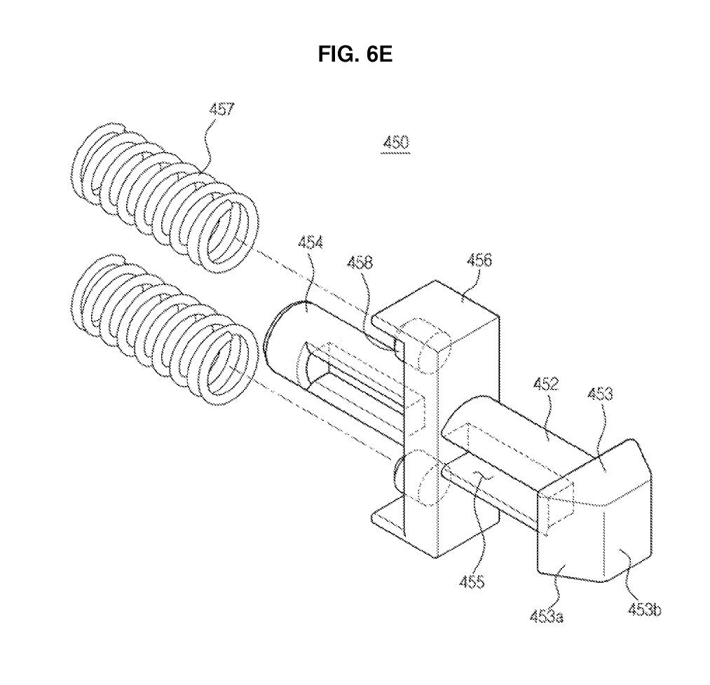

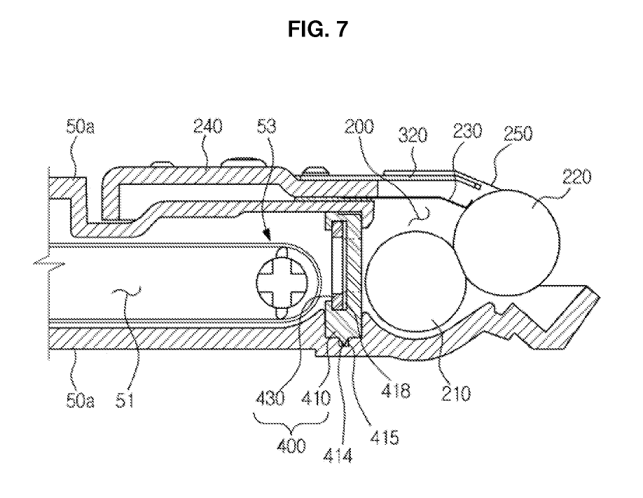

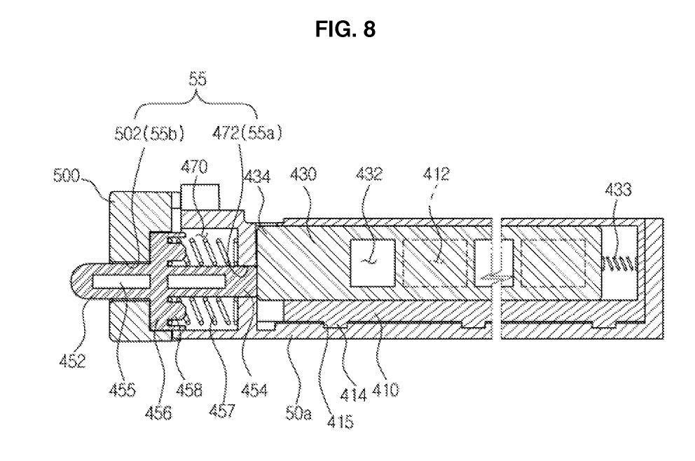

FIG. 3 is an exploded perspective view of a developing unit in accordance with an embodiment, FIG. 4 is an exploded perspective view of an opening/closing unit and a cap shutter in accordance with an embodiment, FIG. 5 is a cross-sectional view of an exemplary opening/closing unit, FIGS. 6A, 6B, 6C, 6D, and 6E illustrate exemplary shapes of a cap shutter, FIG. 7 illustrates an exemplary development unit housing, and FIG. 8 illustrates an exemplary cover plate and slide shutter.

The developing unit 50 may include a developing unit housing 50a that forms an exterior and is configured to be mounted on the support unit 120, a developing agent storage chamber 51 which is installed inside the developing unit housing 50a and in which a developing agent is stored, and a developing chamber 200 that communicates with the developing agent storage chamber 51 via a path 52.

In the developing chamber 200, the developing agent may be transported to the photosensitive body 40 from the developing agent storage chamber 51, and the developing member 220, the supply roller 210, and a regulation member 230 may be provided in the developing chamber 200.

The developing member 220 may include a developing agent transportation portion 220a to which the developing agent is adhered and which forms cylindrical side surfaces of the developing member 220, and a developing member support portion 220b that supports the developing member 220 and forms a center of rotation.

The supply roller 210 may include a supply roller surface portion 210a that supplies the developing agent in the developing agent storage chamber 51 to the developing member 220, and a supply roller support portion 210b that supports the supply roller 210 and forms a center of rotation.

A sealing member 250 may be disposed on ends of the supply roller 210 and the developing member 220. The sealing member 250 may be disposed on ends of the developing member 220 and may prevent the developing agent from leaking from the side surfaces of the developing member 220 along the surface of the developing member 220.

The sealing member 250 may include a mounting portion 253 on which ends of the developing member 220 are mounted. The mounting portion 253 may have a circular shape in which a portion of the mounting portion 253 is open, so that a portion of the developing member 220 can be inserted into and mounted on the mounting portion 253.

The regulation member 230 may be provided so that one side thereof contacts the developing member 220 and may regulate the amount of the developing agent transported through the developing member 220.

The regulation member 230 may be classified as a counter type regulation member or a trail type regulation member according to an installation method. In the counter type regulation member, a front end of the regulation member 230 that contacts the developing member 220 is installed to face an opposite direction to a direction in which a developing roller rotates. In the trailer type regulation member, the front end of the regulation member 230 that contacts the developing roller is installed to face the same direction as the direction in which the developing roller rotates.

The counter type regulation member has advantages that a developing agent layer can be uniformly formed and a performance of sealing the developing unit is excellent. However, due to structural characteristics, it may be very disadvantageous to miniaturize the developing unit. The trailer type regulation member is advantageous in miniaturizing the developing unit, but if the regulation member 230 cannot be maintained at an appropriate strength and elasticity, a performance of regulating the developing agent layer and sealing the developing unit may be relatively lowered compared to the counter type regulation member.

Miniaturizing an image forming apparatus 1 is a significant development, and a trailer type regulation member may have a large advantage in miniaturization. An exemplary embodiment can be applied to the counter type regulation member, and an embodiment applied to the trailer type regulation member for miniaturization is described.

A pressurization unit 320 may include a pressurization unit body 321 and a pressurization portion 322.

A fastening portion 332 may be provided at the pressurization unit body 321 and may be coupled to the developing unit housing 50a. The fastening portion 332 may be fixed to both sides of a regulation member bracket 240 on which the regulation member 230 is supported.

The pressurization unit body 321 may be configured so that one side thereof may be coupled to and fixed to the developing unit housing 50a or the regulation member bracket 240 and the other side thereof closely contacts one side of the sealing member 250 and pressures one surface of the sealing member 250.

The pressurization portion 322 may extend from the pressurization unit body 321. The pressurization portion 322 may be bent from the pressurization unit body 321 so as to press the sealing member 250.

The developing agent storage chamber 51 may be provided inside the developing unit housing 50a to store the developing agent. The developing agent storage chamber 51 may be provided to communicate with the developing chamber 200.

The path 52 which is formed of upper and lower walls and both sidewalls of the developing agent storage chamber 51 and on which the developing agent is guided, may be provided at one side that communicates with the developing chamber 200. A transportation member 53 having a transportation belt and a transportation roller may be provided inside the developing agent storage chamber 51 and may serve to push the developing agent in the developing agent storage chamber 51 toward the path 52.

The opening/closing unit 400 may be formed on the path 52 and limits a supply of the developing agent to the developing chamber 200 from the developing agent storage chamber 51. When the developing unit 50 is included, the developing agent storage chamber 51 and the developing chamber 200 may be partitioned off so as to prevent a leakage of the developing agent, and when the developing unit 50 is coupled into, and mounted into, the image forming apparatus 1, the developing agent storage chamber 51 and the developing chamber 200 need to be provided to be open. When the developing unit 50 exits the image forming apparatus 1, the opening/closing unit 400 is closed and prevents a leakage of the developing agent, and when the developing unit 50 is mounted on the image forming apparatus 1, the opening/closing unit 400 is open and causes the developing agent to be supplied to the developing chamber 200.

The opening/closing unit 400 may include a guide shutter 410 and a slide shutter 430.

The guide shutter 410 may be disposed on the path 52. The guide shutter 410 may include a guide shutter body 411 that closely contacts the path 52 formed by the upper and lower walls and both sidewalls of the developing agent storage chamber 51 and at least one developing agent supply hole 412 disposed in the guide shutter body 411. The guide shutter body 411 may block the path 52 and may cause the developing agent to be supplied to the developing chamber 200 from the developing agent storage chamber 51 only through the developing agent supply holes 412. A mounting protrusion 414 may be provided on one of inner walls of the developing agent storage chamber 51 that form the guide shutter body 411 and the path 52. A mounting groove 415 may be provided in the other one of the inner walls of the developing agent storage chamber 51 so that the guide shutter 410 can contact or can be fixed to the path 52.

The guide shutter 410 may include guide rails 413. The guide rails 413 may be provided at upper and lower parts of the guide shutter 410 in a lengthwise direction of the guide shutter body 411 and may be provided so that one side of a slide shutter 430 may contact the guide rails 413 and the slide shutter 430 can be moved along the guide rails 413.

The guide rails 413 may include a guide extension portion 413a having a shape of a flange that protrudes and extends from upper and lower parts of the guide shutter 410 to one side of the slide shutter 430 and a holding portion 413b that is bent from the guide extension portion 413a by at least a portion of the other side of the slide shutter 430.

A mounting movement portion 416 in which the slide shutter 430 contacts the guide shutter 410 and slides through the guide shutter body 411 and the guide rails 413 may be provided.

Since the slide shutter 430 needs to contact a space between the holding portion 413b and the guide shutter body 411, the guide extension portion 413a may be deformed according to a thickness of the slide shutter 430.

The slide shutter 430 may be provided to contact the guide shutter 410 and to slide, and the developing agent supply holes 412 of the guide shutter 410 may be provided to be selectively open and closed through sliding movement.

The slide shutter 430 may include a slide shutter body 431 that corresponds to the guide shutter body 411 and developing agent injection holes 432 disposed in the slide shutter body 431.

The slide shutter body 431 may include a pair of transverse frames 431a formed at upper and lower parts of the slide shutter body 431 in a lengthwise direction and a longitudinal frame 431b that extends from the pair of transverse frames 431a and that is formed between the pair of transverse frames 431a. The developing agent injection holes 432 may be formed by the transverse frames 431a and the longitudinal frame 431b.

The longitudinal frame 431b may be referred to as a sealing portion 431c, and the sealing portion 431c and the developing agent injection holes 432 may be provided to selectively correspond to the developing agent supply holes 412 of the guide shutter 410 by sliding movement of the slide shutter 430.

Since a same number of the developing agent supply holes 412 and the developing agent injection holes 432 may be provided and at the same intervals, the developing agent injection holes 432 and the developing agent supply holes 412 may coincide with each other, or the sealing portion 431c and the developing agent supply holes 412 may coincide with each other by movement of the slide shutter 430.

A shutter pressurization portion 434 provided at one end of the slide shutter 430 may be pressurized by movement of the cap shutter 450 that will be described below so that the slide shutter 430 can slide. A shutter elastic member 433 may be provided at the other end of the slide shutter 430 so as to be inserted into an inside of the developing unit housing 50a. When the cap shutter 450 moves to an outside of the developing unit housing 50a, the shutter elastic member 433 causes the slide shutter 430 to be moved to an opposite side and causes the opening/closing unit 400 to be maintained in a closed state.

The shutter pressurization portion 434 may be provided at one end of the slide shutter 430, may have a larger cross-sectional area than that of the slide shutter body 431 and may have a large contact area with a pushing protrusion 454 of the cap shutter 450.

The slide shutter 430 may closely contact the guide shutter 410 and may slide, and no gap may be formed between the slide shutter 430 and the guide shutter 410. The guide shutter 410 may include a sealing film 418 that is provided at a portion in which the slide shutter 430 contacts the guide shutter 410.

The sealing film 418 may include an elastic portion 418a and a film portion 418b. The elastic portion 418a may cause the guide shutter 410 and the slide shutter 430 to closely contact each other and may prevent the developing agent from leaking from the developing agent storage chamber 51 toward the developing chamber 200, and the film portion 418b may be configured to reduce friction between the guide shutter 410 and the slide shutter 430.

The cap shutter 450 may be configured so that the developing unit 50 is mounted on/detached from the support unit 120 and the cap shutter 450 advances and retreats so as to open/close the opening/closing unit 400. Due to the chamfer portion 122a provided at the support unit 120, the cap shutter 450 advances and retreats due to an external force applied to the cap shutter 450, and advance and retreat movements of the cap shutter 450 cause the slide shutter 430 to slide.

The developing unit 50 may include a cover plate 500 that covers a portion of the developing unit housing 50a in a lateral direction of the developing unit housing 50a. The cap shutter 450 may be disposed between the developing unit housing 50a and the cover plate 500. The cover plate 500 may prevent the cap shutter 450 from detaching from the developing unit housing 50a and may guide an operation of the cap shutter 450. One end of the cap shutter 450 may be exposed to the outside through a plate hole 502 provided in the cover plate 500, and the other end of the cap shutter 450 may contact the slide shutter 430 through a pushing protrusion hole 472 provided in the developing unit housing 50a.

A guide hole 55 includes a first guide hole 55a and a second guide hole 55b. The first guide hole 55a may be the same as the pushing protrusion hole 472, and the second guide hole 55b may be the same as the plate hole 502. Due to the guide hole 55, movement of the cap shutter 450 may be restricted only by advance and retreat movement, and movement of the cap shutter 450 may be guided.

The cap shutter 450 may include a cap portion 452 that contacts the chamfer portion 122a and a pushing protrusion 454 that contacts the slide shutter 430.

The cap portion 452 may be configured to contact the chamfer portion 122a of the support rails 122 at one end of the cap shutter 450 and may be provided to protrude toward the outside of the cover plate 500.

The shape of the cap portion 452 is not limited thereto. However, in an embodiment, the cap portion 452 may be provided in a hemispherical shape, as illustrated in FIG. 6A. The cap portion 452 may be shaped, as illustrated in FIGS. 6B, 6C, 6D, and 6E, and the cap portion may be provided so that the cap shutter 450 can contact the chamfer portion 122a and advance and retreat.

The cap portion 452 may include guide surfaces 452aa, 452ba, 452ca, 452da, and 453a and pressurization surfaces 452ab, 452bb, 452cb, 452db, and 453b that are formed at an end of the cap portion 452.

The guide surfaces 452aa, 452ba, 452ca, 452da, and 453a are surfaces on which the cap shutter 450 contacts the chamfer portion 122a so as to move and guide the cap shutter. The pressurization surfaces 452ab, 452bb, 452cb, 452db, and 453b are provided at a dead end of the cap portion 452 and are provided to contact side surfaces of the support rails 122 so that the cap shutter 450 that moves to an inside of the developing unit housing 50a can be maintained in the moved state.

FIG. 6A illustrates an embodiment of the cap portion 452. The guide surface 452aa may be provided in a hemispherical shape, and movement of the cap shutter 450 may be guided on the guide surface 452aa. The pressurization surface 452ab may be provided in a shape of a dot at an end of the guide surface 452aa and may contact side surfaces of the support rails 122.

FIG. 6B illustrates another embodiment of the cap portion 452. The guide surface 452ba may be provided in a portion of a hemispherical shape, and movement of the cap shutter 450 may be guided on the guide surface 452ba. The pressurization surface 452bb may be provided in a shape of a plane at an end of the guide surface 452ba and may contact side surfaces of the support rails 122.

FIG. 6C illustrates another embodiment of the cap portion 452. The guide surface 452ca may be provided in a tripod shape, and movement of the cap shutter 450 may be guided on the guide surface 452ca. The pressurization surface 452cb may be provided in a shape of a plane at an end of the guide surface 452ca and may contact side surfaces of the support rails 122.

FIG. 6D illustrates another embodiment of the cap portion 452. The guide surface 452da may be provided in a chamfer shape so that a portion of an edge of the end of the cap portion 452 can be inclined, and movement of the cap shutter 450 may be guided on the guide surface 452da. The pressurization surface 452db may be provided in a shape of a plane while having a common edge with the guide surface 452da and may contact side surfaces of the support rails 122.

FIG. 6E illustrates another embodiment of the cap portion 452. The cap portion 452 may include a head portion 453 that has a larger diameter than that of the cap portion 452 and that is formed at an end of the cap portion 452. The head portion 453 may be provided in a shape of a square pillar having trapezoidal top and bottom surfaces. A surface having a large area among side surfaces of the square pillar including parallel top and bottom segments of the trapezoid may be referred to as a first surface, a surface having a small area among the side surfaces may be referred to as a second surface and a side surface that connects the first surface and the second surface may be referred to as a third surface, and the guide surface 453a may be provided on the third surface, and movement of the cap shutter 450 may be guided, and the pressurization surface 453b may be provided on the second surface and may contact side surfaces of the support rails 122.

The pushing protrusion 454 may be configured to extend from the cap portion 452 and to contact the slide shutter 430 so that the slide shutter 430 can slide. That is, one end of the pushing protrusion 454 may contact the cap portion 452, and the other end of the pushing protrusion 454 may contact an end of the slide shutter 430.

The cap shutter 450 may include a flange guide 456 disposed between the cap portion 452 and the pushing protrusion 454, an elastic member 457, and an elastic member fixing portion 458.

The developing unit housing 50a may include a cap shutter mounting portion 470 on which the cap shutter 450 can mount on an outside of the developing unit housing 50a. The flange guide 456 may prevent the cap shutter 450 from moving in directions within the cap shutter mounting portion 470 other than advance/retreat movements and may support the elastic member 457 and the elastic member fixing portion 458. The flange guide 456 may extend in a flange shape from side surfaces of the cap shutter 450 and may guide an operation of the cap shutter 450.

The elastic member 457 may be provided at one side of the flange guide 456. One end of the elastic member 457 may contact the flange guide 456, and the other end of the elastic member 457 may contact outer walls of the developing unit housing 50a that forms the cap shutter mounting portion 470 so as to elastically support the cap shutter 450. The elastic member fixing portion 458 may be provided at a portion in which one side of the flange guide 456 and the elastic member 457 contact each other, may protrude from the flange guide 456 and may prevent detachment of the elastic member 457.

The cap shutter 450 may be elastically supported, and when the developing unit 50 is removed from the support unit 120, the cap shutter 450 may be pushed toward the outside of the developing unit housing 50a. The elastic member 457 may be provided to surround a periphery of the pushing protrusion 454 and may elastically support the cap shutter 450. The shape of the cap shutter 450 is not limited thereto, and the cap shutter 450 may be configured so that the cap shutter 450 can be elastically supported and when the developing unit 50 escapes from the support unit 120, the cap shutter 450 can be pushed toward the outside of the developing unit housing 50a.

The cap shutter 450 may be disposed between the developing unit housing 50a and the cover plate 500 and may be mounted on the cap shutter mounting portion 470 disposed at the developing unit housing 50a.

The cap portion 452 at one end of the cap shutter 450 may protrude toward the outside through the plate hole 502 of the cover plate 500, and the pushing protrusion 454 at the other end of the cap shutter 450 may pass through the pushing protrusion hole 472 of the developing unit housing 50a and may contact the slide shutter 430.

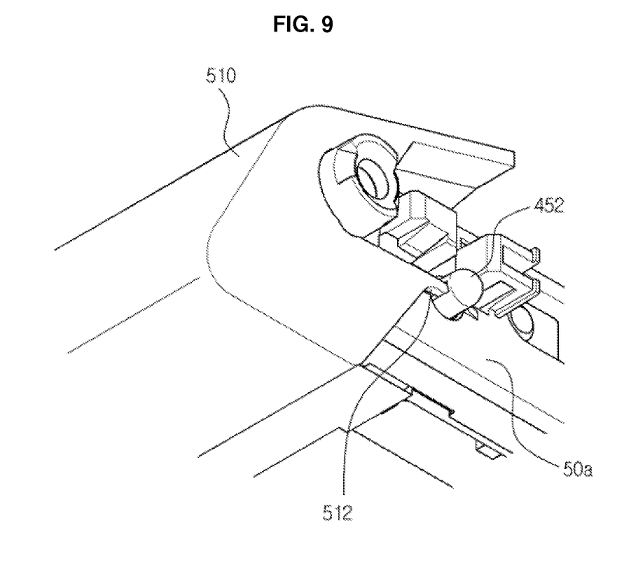

FIG. 9 is a perspective view of a cap shutter and a storage bracket in accordance with an embodiment.

The cap shutter 450 may include an escape prevention groove 455 that is provided in a groove shape in a side surface of the cap portion 452 in a lengthwise direction of the cap portion 452. When the developing unit 50 is not mounted on the image forming apparatus 1 and is separately kept and distributed, the developing unit 50 may be protected by a protection bracket 510 that may protect the developing unit 50. An insertion protrusion 512 provided at the protection bracket 510 may be coupled to the escape prevention groove 455 and may prevent the cap shutter 450 from being inserted into an inside of the developing unit housing 50a due to carelessness or another external force.

An operation of an embodiment caused by insertion and removal of the developing unit and the image forming apparatus having the developing unit is described.

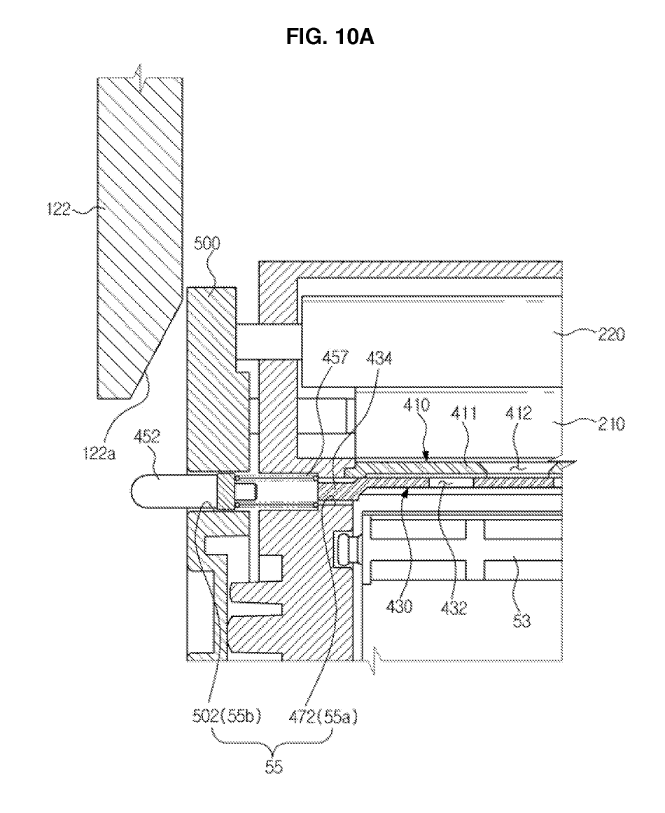

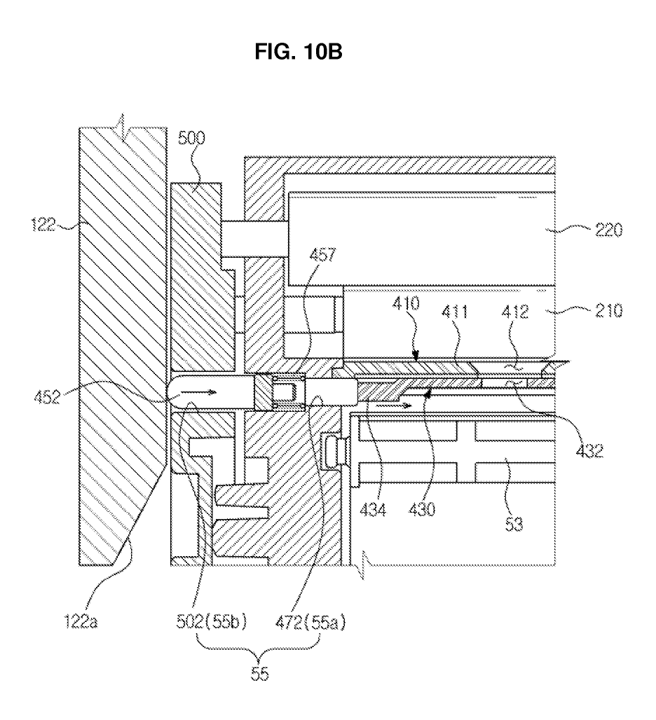

FIGS. 10A and 10B illustrate a developing unit mounted on an image forming apparatus, in accordance with an embodiment.

When the developing unit 50 is removed from the image forming apparatus 1, the developing agent supply holes 412 of the guide shutter 410 are provided not to coincide with the developing agent injection holes 432 of the slide shutter 430 and to correspond to the sealing portion 431c. The developing agent supply holes 412 of the guide shutter 410 are provided to be maintained in the closed state by the shutter elastic member 433 provided at an end of the slide shutter 430.

When the developing unit 50 is mounted on the support unit 120 of the image forming apparatus 1, the cap shutter 450 provided at the developing unit 50 may be pushed toward an inside of the developing unit housing 50a by the chamfer portion 122a of the support unit 120.

The cap portion 452 of the cap shutter 450 is pushed by the chamfer portion 122a, and the pushing protrusion 454 at the other end of the cap shutter 450 pushes the slide shutter 430. When the slide shutter 430 is pushed, the developing agent supply holes 412 coincide with the developing agent injection holes 432. Thus, the developing agent in the developing agent storage chamber 51 is moved to the developing chamber 200 through the developing agent injection holes 432 and the developing agent supply holes 412 so that the opening/closing unit 400 can operate in an open state.

When the developing unit 50 repeatedly escapes from the image forming apparatus 1, the cap shutter 450 is not confined by the chamfer portion 122a and is moved to an outside of the developing unit housing 50a. The slide shutter 430 slides due to the shutter elastic member 433, and the developing agent supply holes 412 corresponds to the sealing portion 431c of the slide shutter 430 so that the opening/closing unit 400 can operate in a closed state.

In a developing unit and an image forming apparatus according to the one or more embodiments, developing agent storage chambers provided to be closed when being distributed can be open simultaneously when the developing unit is mounted on the image forming apparatus so that a leakage of a developing agent can be prevented and durability of the developing unit can be improved.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A developing unit mounted on an image forming apparatus, the developing unit comprising:
a housing;
a developing agent storage chamber that is provided inside the housing and in which a developing agent is stored;
a developing chamber that communicates with the developing agent storage chamber;
a path on which the developing agent is moved from the developing agent storage chamber to the developing chamber; and
an opening/closing unit that is provided on the path and is open/closed when the housing is mounted on/detached from the image forming apparatus,
wherein the opening/closing unit comprises:
a guide shutter having at least one developing agent supply hole; and
a slide shutter that opens/closes the at least one developing agent supply hole of the guide shutter.

2. The developing unit according to claim 1, further comprising a cap shutter that opens/closes the opening/closing unit when the housing is mounted on/detached from the image forming apparatus.

3. The developing unit according to claim 2, wherein the cap shutter comprises:
a cap portion that protrudes toward an outside of the housing and moves due to an external force; and
a pushing protrusion that extends from the cap portion and causes the slide shutter to slide.

4. The developing unit according to claim 1, wherein the slide shutter comprises at least one developing agent injection hole corresponding to the at least one developing agent supply hole according to sliding movement.

5. The developing unit according to claim 4, wherein a plurality of developing agent supply holes and a plurality of developing agent injection holes are provided at the same intervals.

6. The developing unit according to claim 1, wherein the slide shutter comprises:
a shutter pressurization portion that is provided at one end of the slide shutter so that the slide shutter is capable of sliding in one direction due to an external force applied to the cap shutter; and
a shutter elastic member that is provided at the other end of the slide shutter so that the slide shutter is capable of sliding in the other direction due to an elastic force.

7. The developing unit according to claim 6, wherein the opening/closing unit slides in one direction due to an external force applied to the shutter pressurization portion and is open and slides in the other direction due to an elastic force of the shutter elastic member and is closed.

8. The developing unit according to claim 1, wherein the guide shutter further comprises a guide shutter body that blocks the path on which the developing agent is capable of moving only through the at least one developing agent supply hole.

9. The developing unit according to claim 1, wherein the guide shutter further comprises guide rails so that the slide shutter is capable of closely contacting the guide shutter and sliding along the guide rails.

10. The developing unit according to claim 3, wherein the cap portion is inserted into the housing when the housing is mounted on the image forming apparatus.

11. The developing unit according to claim 3, wherein an end of the cap portion is formed in a hemispherical shape.

12. The developing unit according to claim 2, wherein the cap shutter is elastically supported to an outside of the housing.

13. The developing unit according to claim 3, wherein the cap shutter comprises:
at least one flange guide that extends in a flange shape from the cap portion; and
an elastic member provided so that the at least one flange guide is elastically supported on the housing.

14. The developing unit according to claim 2, wherein the housing comprises a guide hole through which movement of the cap shutter is guided.

15. The developing unit according to claim 2, further comprising a cover plate provided at the outside of the housing so as to prevent detachment of the cap shutter.

16. The developing unit according to claim 1, wherein the opening/closing unit further comprises a sealing film that causes the guide shutter and the slide shutter to closely contact each other and that is provided between the guide shutter and the slide shutter so as to prevent a leakage of the developing agent.

17. An image forming apparatus comprising:
a body;
a developing unit housing comprising a developing agent storage chamber in which a developing agent is stored and a developing chamber that communicates with the developing agent storage chamber and that has a developing member for transporting the developing agent to a photosensitive body on which an electrostatic latent image is formed, the developing unit housing being mounted on a support unit provided inside the body;
a path on which the developing agent is moved from the developing agent storage chamber to the developing chamber;
an opening/closing unit comprising a guide shutter having at least one developing agent supply hole and a slide shutter having developing agent injection holes that selectively correspond to the at least one developing agent supply hole according to sliding movement, the opening/closing unit opening/closing the path; and
a cap shutter provided at an end of the slide shutter so as to move the slide shutter.

18. The image forming apparatus according to claim 17, wherein the support unit comprises:
support rails on which mounting of the developing unit housing is guided; and
a chamfer portion that is provided at an end of the support rails and that pressurizes the cap shutter so that the cap shutter is capable of moving to an inside of the developing unit housing.
